(19) United States
(12) Patent Application Publication
(10) Pub. No.: US 2016/0293032 A1
(43) Pub. Date: Oct. 6, 2016

(54) Video Instruction Methods and Devices

(71) Applicant: Drexel University, Philadelphia, PA (US)

(72) Inventor: Christof J. Daetwyler, Philadelphia, PA (US)

(21) Appl. No.: 15/089,720

(22) Filed: Apr. 4, 2016

Related U.S. Application Data
(60) Provisional application No. 62/142,839, filed on Apr. 3, 2015.

(51) Int. Cl. G09B 5/06

(52) U.S. Cl. CPC G09B 5/065

(57) ABSTRACT

Video instruction methods and devices aid in creation of enhanced training and evaluation materials using existing video. Instructors may annotate the video to highlight particular activities taking place during the video, and students can be tested on their ability to identify these activities.

### BACKGROUND

Trainers and teachers often use videos and animations. The proliferation of personal computing and connectivity via the Internet and other networks makes adoption of video instruction even more attractive, in fields from academic study and medical training to skills, technical, and even physical training. In this context, there exists an opportunity to provide improved instruction using video technologies.

### SUMMARY

The methods and apparatus described herein allow for the creation of enhanced training and evaluation materials using existing video. Instructors may annotate the video to highlight selected activities occurring during the video and test students on their ability to identify these activities. A student may also receive performance evaluation and feedback.

A video learning device for administering a comparison test comprises: identifying an annotation; associating the annotation with a time range within a video; presenting the video and the annotation to a user; receiving a selection of a time point within the video from the user; and evaluating if the time point corresponds to the time range.

### BRIEF DESCRIPTION OF THE DRAWINGS

A more detailed understanding may be had from the following description, given by way of example in conjunction with the accompanying drawings.

FIG. 1 shows a method workflow for video instruction.

FIG. 2 shows a method workflow for creating an annotated instruction video usable with the method of FIG. 1.

FIG. 3 shows annotation data produced by the method of FIG. 2 and usable with the method of FIG. 1.

FIG. 4 shows a method workflow for administering an assignment based upon an annotated video usable with the method of FIG. 1.

FIG. 5 shows selection data produced by the method of FIG. 4 and usable with the method of FIG. 1.

FIG. 6 shows a method workflow for evaluating the selection data of FIG. 5, which is usable with the method of FIG. 1.

FIG. 7 shows evaluation data produced by the method of FIG. 6, which is usable with the method of FIG. 1.

FIG. 8 shows a data flow for FIGS. 1-7.

FIG. 9 shows an implementation of the methods described with respect to FIGS. 1-8.

FIG. 10 shows a user interface for an implementation of the methods described with respect to FIGS. 1-8.

FIG. 11 shows another aspect of a user interface for an implementation of the methods described with respect to FIGS. 1-8.

FIG. 12 shows another aspect of a user interface for an implementation of the methods described with respect to FIGS. 1-8.

FIG. 13 shows another aspect of a user interface for an implementation of the methods described with respect to FIGS. 1-8.

FIG. 14 shows an interface for video input.

FIG. 15 shows an interface for selecting and annotating time ranges of a video.

FIG. 16 shows further features of the annotation interface of FIG. 15.

FIG. 17 shows an interface for selecting and annotating time ranges.

FIG. 18 shows an interface for viewing annotated video during playback.

FIG. 19 shows an editing interface for editing an annotation.

FIG. 20 shows a graphical interface usable for creating an assignment based upon an annotated video.

FIG. 21 shows an interface for a user interacting with an assignment based upon the annotated vide.

FIG. 22 shows the interface of FIG. 21 after the user has made several selections.

FIGS. 23A and 23B show an interface for an administrator of an assignment based upon an annotated video.

FIG. 24 shows an interface for display of correct and incorrect selections during administration of an assignment based upon an annotated video.

FIG. 25 shows an enlarged portion of the interface shown in FIG. 24.

FIGS. 26-28 show the application in use.

### DETAILED DESCRIPTION

An assignment creation system may include a web-based application that allows an instructor to create an enhanced video by inserting time-based annotations on a video while it is playing. When finished, the instructor may indicate completion by clicking a “Submit” button, for example, whereupon the system generates an assignment. Example annotations for medical instruction, for example, might be of the form:

Time Range/Annotation

1:10-1:12/Patient describes symptoms

1:30-1:45/Doctor describes diagnosis

Other suitable annotation formats are possible.

Users may also use annotations outside the context of an assignment, for instance, for informational purposes when viewing the video. Annotations may also include hyperlinks to additional content such as web pages or online videos. These hyperlinks may be used to provide meta-information such as background information, clinical reasoning, or other guidance.

Such meta-information may serve to change the nature of an instructional or role-modeling video that serves as the basis for the enhanced video from a linear medium to one which plays differently depending on a user's interest. This permits the use of the enhanced video for teaching different audiences. For example, novice users who may access much or all of the meta-information) may use an enhanced video, and advanced users (who may access little or none of the meta-information) may also access the enhanced video.

In some implementations the instructor may provide student e-mail addresses or other electronic contact information, and an assignment may be created for and transmitted to each student.

A learning assessment device may also be provided, which may include a web-based application that may present a student with a video assignment. A suitable communications medium such as over the Internet or another network via the web application may transmit the video assignment. The web application may show the enhanced video, including a list of the annotations, while withholding the time ranges associated with each annotation.

As the student watches the video, the student may select an appropriate annotation, such as by clicking on a selection palette for example, when the student recognizes corresponding activity occurring in the video. The system associates the student's selection with the particular time during the video corresponding to the annotation.

In addition to selecting annotations at particular times during the video as discussed above, the assessment device may allow the student to enter freeform comments (i.e. other than the annotations) and to associate these comments with a selected point in the video, for example, by placing a marker along the video timeline. The assessment device may provide functionality for an instructor to review these comments remotely. Permitting free-form comments may be used to foster reflection and to check for deeper understanding of the enhanced video. An example of the free-form functionality may include a question prompting a particular type of free-form response, such as “Please set a marker at the time where you think that the physician's effort in helping the patient was most efficient—and explain why!”

To test knowledge of technique in a medical setting for example, the system may ask a question such as: “Please identify when the physician is using team-building skills” This type of question may prompt the student to select a time during the video using a selection button corresponding to the annotations. A further question for a student, to test empathy, may include “Identify when the patient is getting uneasy, and explain why.” This type of question prompts for more detailed information beyond a time selection, and may be implemented using the free-form comment functionality discussed above.

Once complete, an evaluation device may compare the student's selection times with the time ranges associated with each annotation by the instructor. The device may then generate an assessment report, which may include a numeric score and a visual explanation that describes the score's computation method. The visual explanation may show matches and mismatches between the student's selected annotation times and the time ranges associated with the annotations by the instructor.

Devices and methods consistent with the descriptions herein may allow automatic scoring of students' comprehension of situations shown in a video, and may permit testing of whether students are paying attention to the video.

The functions of the assignment creation device and learning assessment device may be implemented as one device, such as for example a computing device having a processor executing software for performing each of these functions. Alternatively, the assignment creation and learning assessment devices may be implemented as several computing devices, each having a processor executing software for performing one or more of these functions and in communication with one another, such as over a computer communications network such as the Internet.

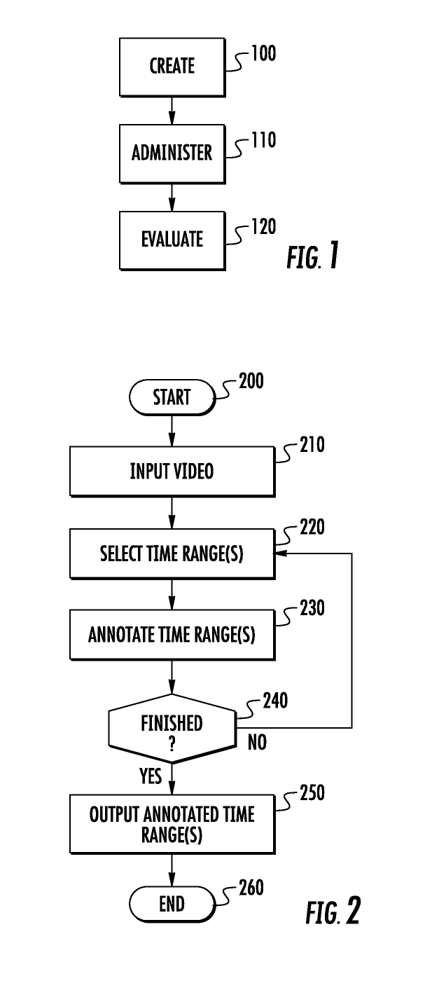

FIG. 1 shows an example method for video instruction, where a user creates an annotated instruction video 100, an instructor creates an assignment based upon the annotated instruction video to a student 110, and the instructor evaluates the student's performance on the assignment 120. An instructor may create the instruction video for a specific lesson or may be a video taken to serve another purpose, but that happens to help teach a lesson. For example, the video may show a politician giving a speech and the annotations may be inserted later.

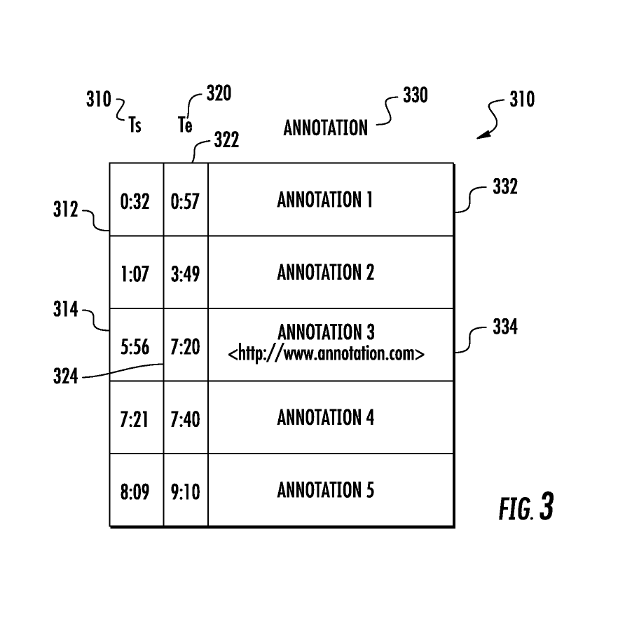

FIG. 2 shows an example method for creating an annotated instruction video usable with the method of FIG. 1. A computing device such as a personal computer, mobile device, or a server computer may execute FIG. 2's method directly or over a communications network.

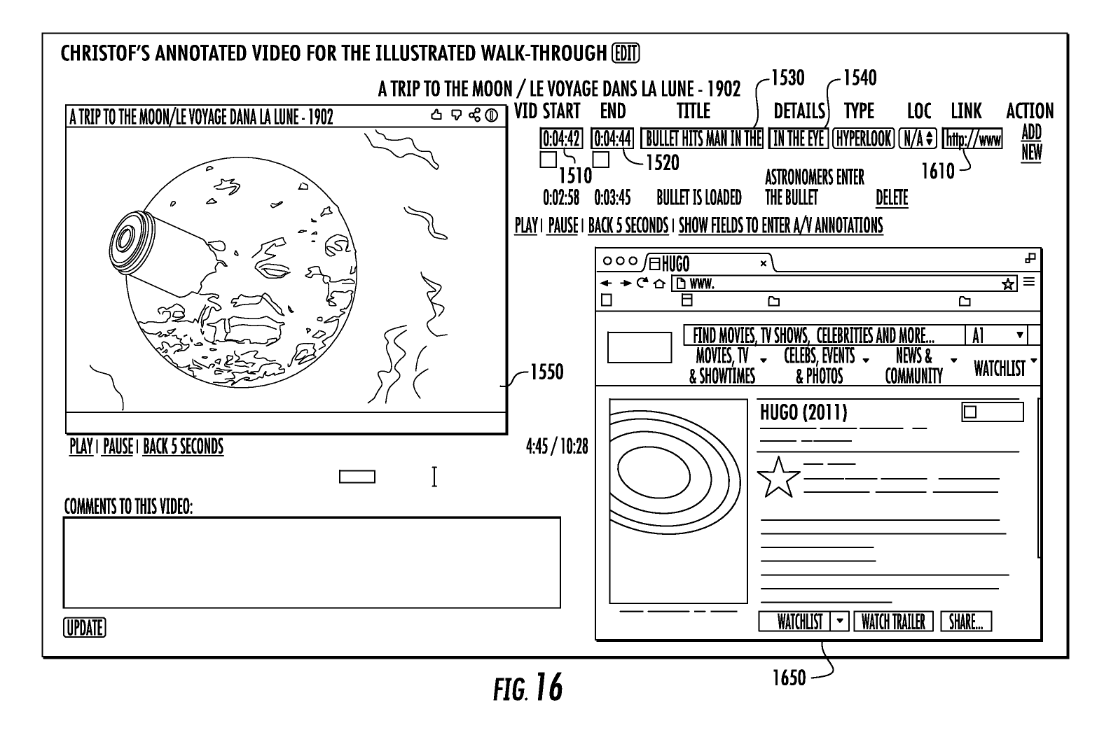

After starting the method 200, a user inputs a video into a device for creating annotations 210, such as by accessing a video that currently resides on a publicly accessible website such as YouTube. The video may be any suitable motion picture containing a scene or scenes useful for instruction. The device for creating annotations may be a computing device having annotation software installed. FIG. 14, for example, shows an example interface for video input.

In FIG. 14, a user may input a code or hyperlink associated with a video on a preset site like YouTube 1410. Or a URL to another video 1420. Following selection, the user may receive feedback on the selection in a status window or popup 1430. The user may annotate a new video based on the previously annotated video as well 1440. A preview window 1450 may show the selected video.

Once input, an annotating user selects one or more time ranges within the video for annotation 220. A user may select the time ranges by marking beginning and ending points for the annotation during playback of the video. The annotation software may also permit selection of a range using one or more sliders on a timeline. Other selection techniques may be possible.

Continuing within FIG. 2, the user may begin to annotate the selected time ranges 230. The annotations may be any data suitable for annotating the selected time range. For example, the annotation may include a description of what is occurring in the video during the selected time range. The annotation may include a hyperlink to further information relating to what is occurring in the video during the selected time range, to another video containing other information, to general background information, or other information.

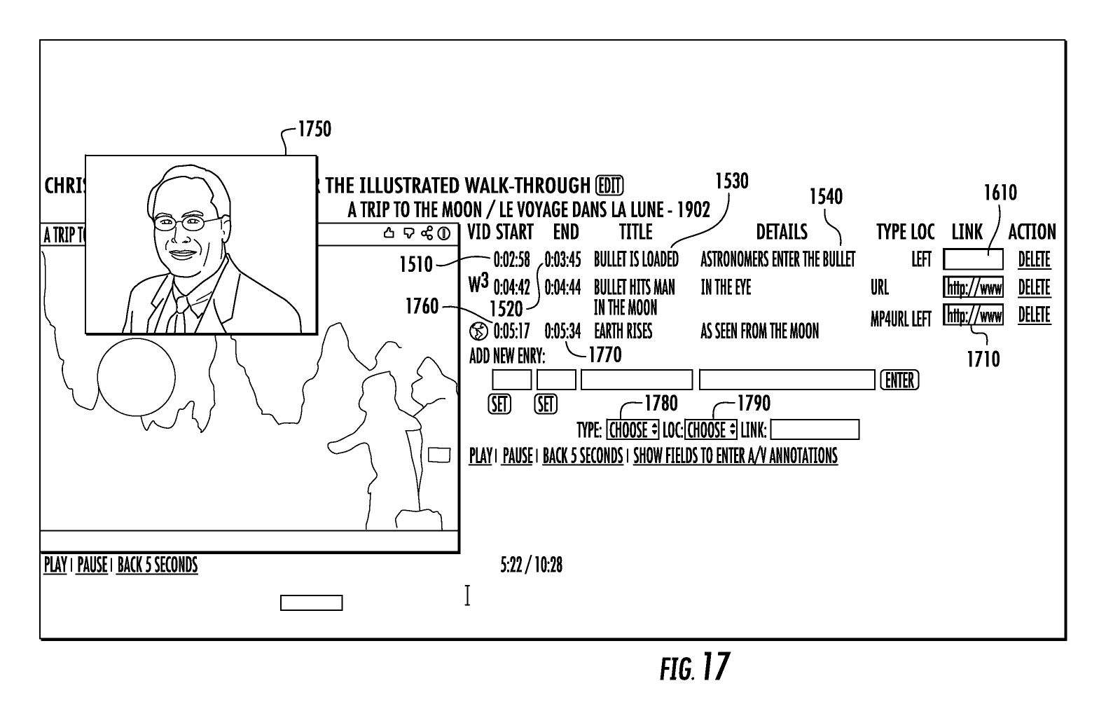

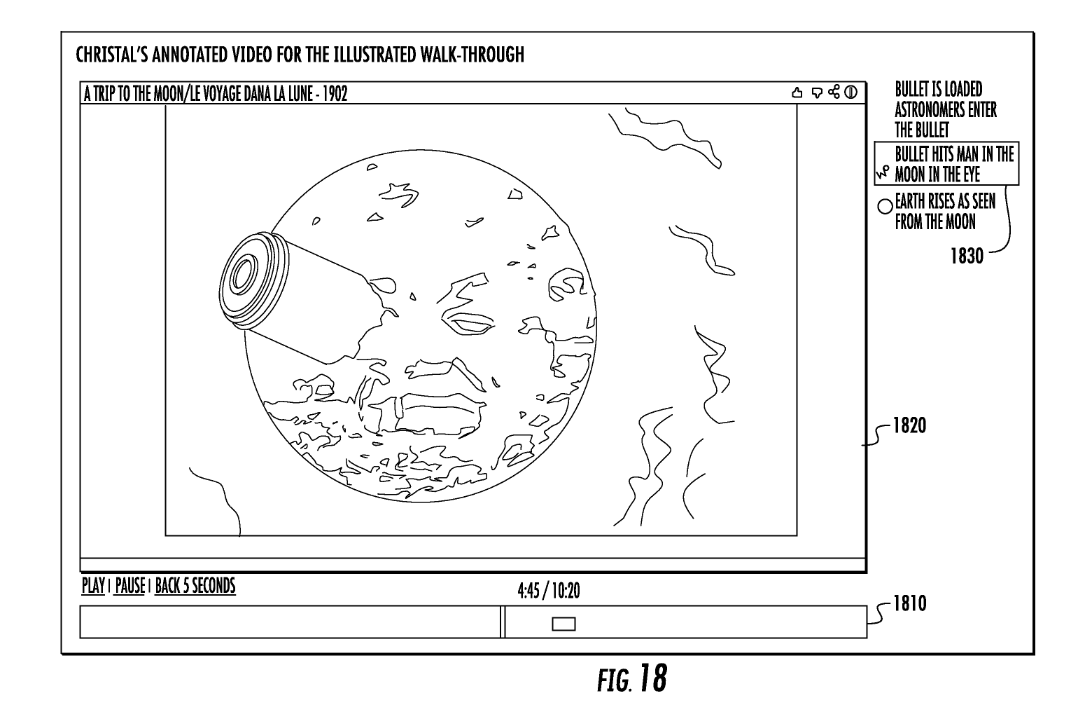

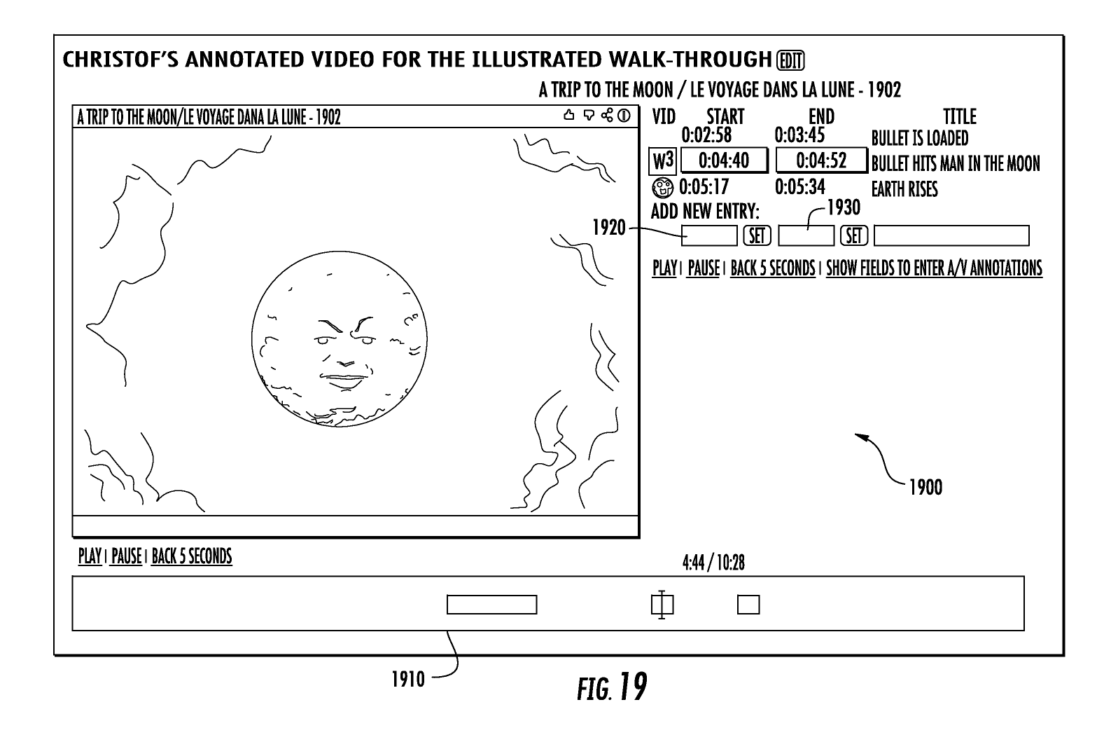

FIG. 15 shows an interface for selecting and annotating time ranges within start and end range input fields 1510 and 1520. A user may also enter title 1530 and details 1540 for the video shown in the preview window 1550. FIG. 16, which shows fields similar to those in FIG. 15, also includes a hyperlink field 1610 and a hyperlink preview pane 1620. FIG. 17 shows an annotation that includes a video annotation preview 1750 derived from a video link entered by a user 1710.

The steps described above have no predetermined order. For example, in some implementations, a user may select a time range for annotation and then annotate before the user selects another time range for annotation. It will also be understood that a user may make the annotations during playback of the video, or without playback of the video such as by selecting time ranges based on preview frames of the video, by selecting time ranges alone using a timeline slider or by typing start and end times for example, or by another suitable technique.

The assignment may be transmitted using e-mail addresses or other suitable electronic messaging addresses. These addresses may be supplied before, during, or after annotating the video, however the assignment may be transmitted to the addressees after annotation is complete.

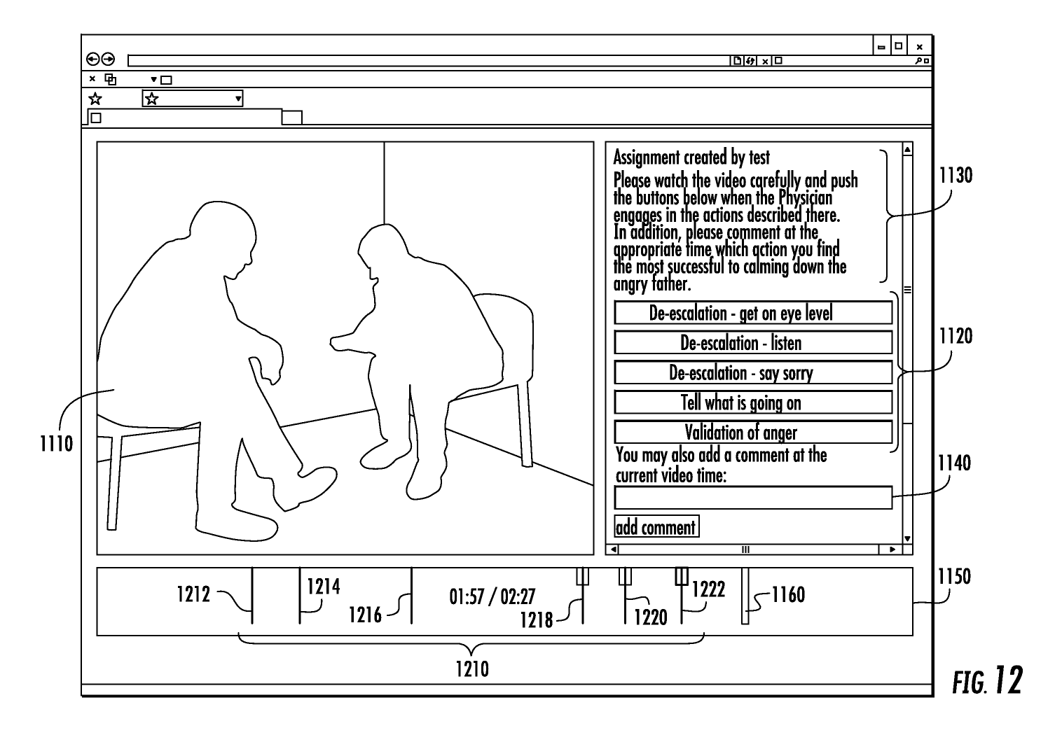

Depending upon the implementation, each addressee may receive a hyperlink or other suitable direction to a web page where the assignment, which may be a test, resides. The web page may include a login screen (such as shown in FIG. 10) or other user authentication mechanism.

If the user finishes 240, the system outputs annotation ranges 250 and finishes 260. If the user is not finished at step 240, the range selection 220 may restart.

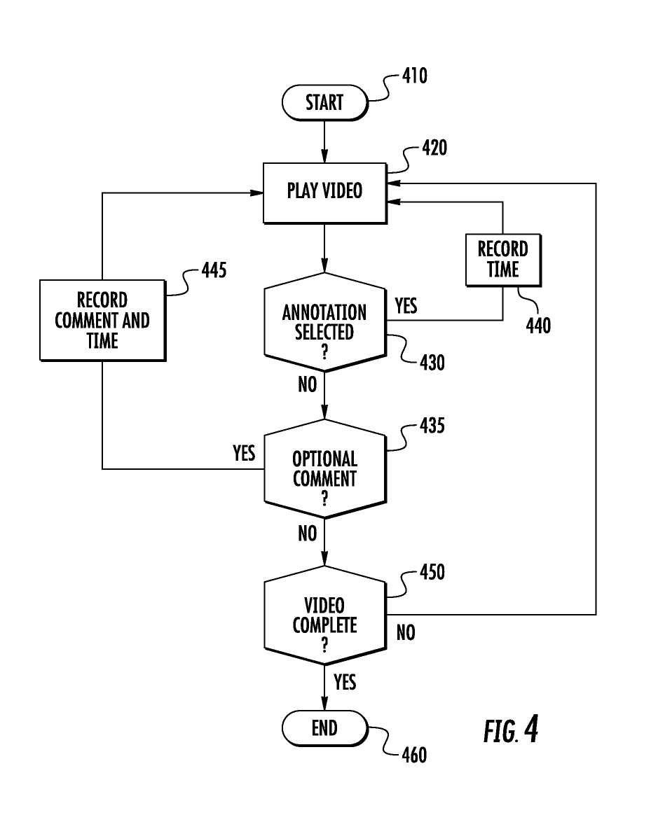

FIG. 3 shows an annotation data table 310 usable with the method of FIG. 1, produced by the annotation method shown in FIG. 2. The table 310 includes start and end annotation times 320 and 330, as well as the stored annotation data 340.

The annotation data 340 associates a time range with an annotation, which may include text, and may include a hyperlink or other type of meta-content. For example, the text “Annotation 1” 332 is associated with a time range within the video starting at Ts=0:32 312 and ending at Te=0:57 322. Another annotation shows “Annotation 3” 334 and a hyperlink to “http://www.annotation” associated with a time range within the video starting at Ts=5:56 314 and ending at Te=7:20 324.

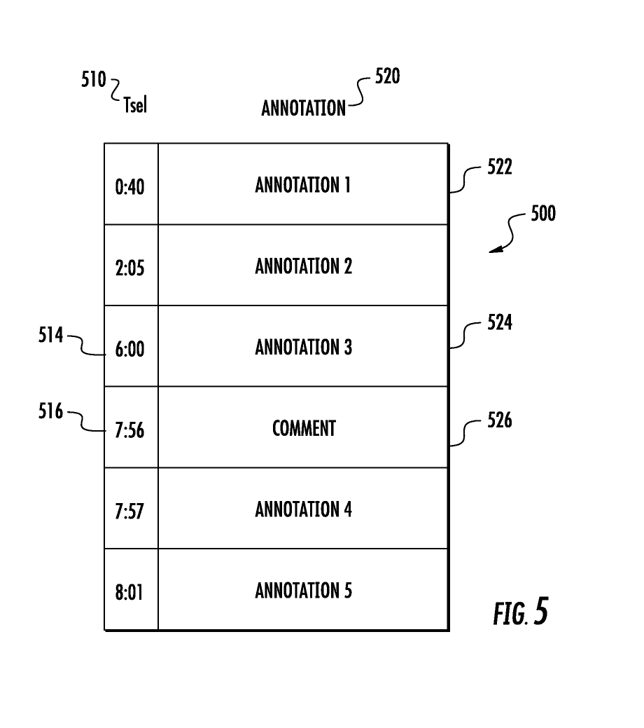

FIG. 4 shows an example method for administrating an assignment based upon the annotated video. The method of FIG. 4 may be implemented on a computing device such as a personal computer or a server computer accessible over a computer communications network, for example.

Following the start of the assignment 410, a teacher may present a student with the video portion of the annotated video 420. The student receives annotations; however, the system may withhold the time ranges associated with the annotations from the student.

The system prompts the student to choose from among annotations while the video plays. The annotations reflect “right” and “wrong” annotations. This may be handled in a number of ways depending upon the desired implementation. For example, the system may present a user with the annotations in list form alongside the video, with each annotation being selectable. When presented, the student may select an annotation relevant to the annotation 430. In some implementations, the system may prompt the student to add their own annotation or free-form comment at the current or another video time 435.

Upon selection of one of the annotations (or optional comment 435), the system associates the current time position of the video with the chosen annotation and records this selection data 440, 445.

If the video is complete 450, the sequence may end 460 and if not, the system can play the video again 420.

In some implementations, the system can present a timeline of the video to the user, and may show markers at each time along the timeline where an annotation was selected. The timeline may also show a cursor at the current video time position along the timeline.

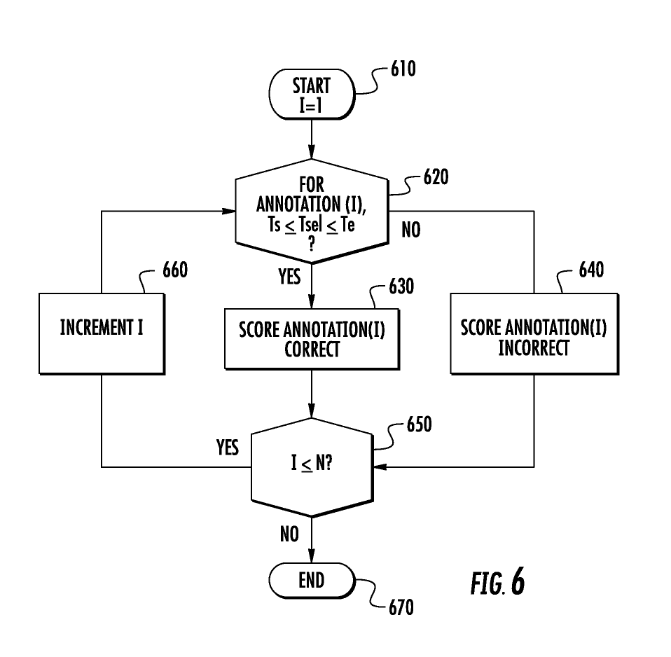

FIG. 5 shows a selection data table 500 usable with the method of FIG. 1 produced by the assignment shown in FIG. 4. The selection data associates a selection time 510 with an annotation 520. For example, the “Annotation 1” is shown associated with a selection time of Tsel=0:40 512, and “Annotation 3” 524 is shown associated with a selection time of Tsel=6:00 514.

In addition to the annotations, the system associated a freeform comment 526 associated with a selection time of Tsel=7:56 516. Such freeform commenting may be optional.

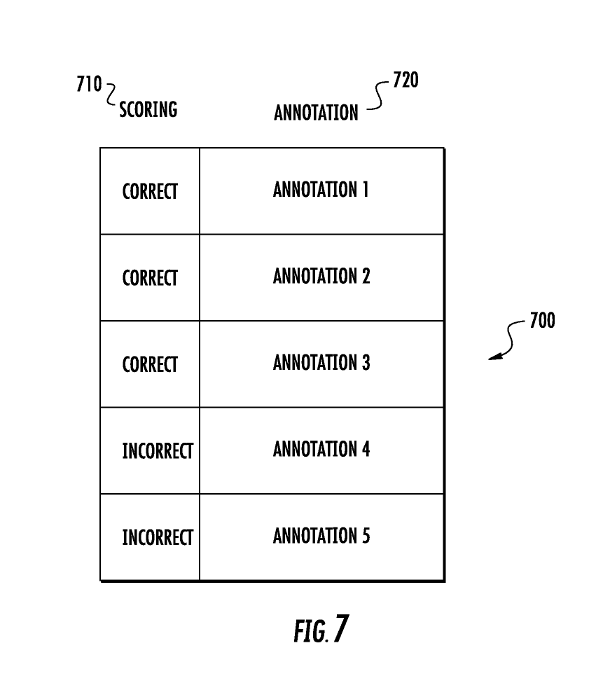

FIG. 6 shows a method for evaluating the student-selected data from FIG. 4. The method of FIG. 6 may be implemented on a computing device such as a personal computer or a server computer accessible over a computer communications network, for example.

For each annotation (I=1−n) 610, the system compares an associated selected time Tsel with the start (Ts) and end (Te) times of the time range associated with that annotation 620. If the selected time falls within the time range, a correct evaluation is associated with that annotation 630. If the selected time falls outside the range, an incorrect evaluation is associated with that annotation 640. In this way, a user may be graded accordingly or may be presented with performance feedback. If there are more annotations to score 650, the system moves to the next annotation 660 and repeats the steps. Otherwise the system finishes the process 670

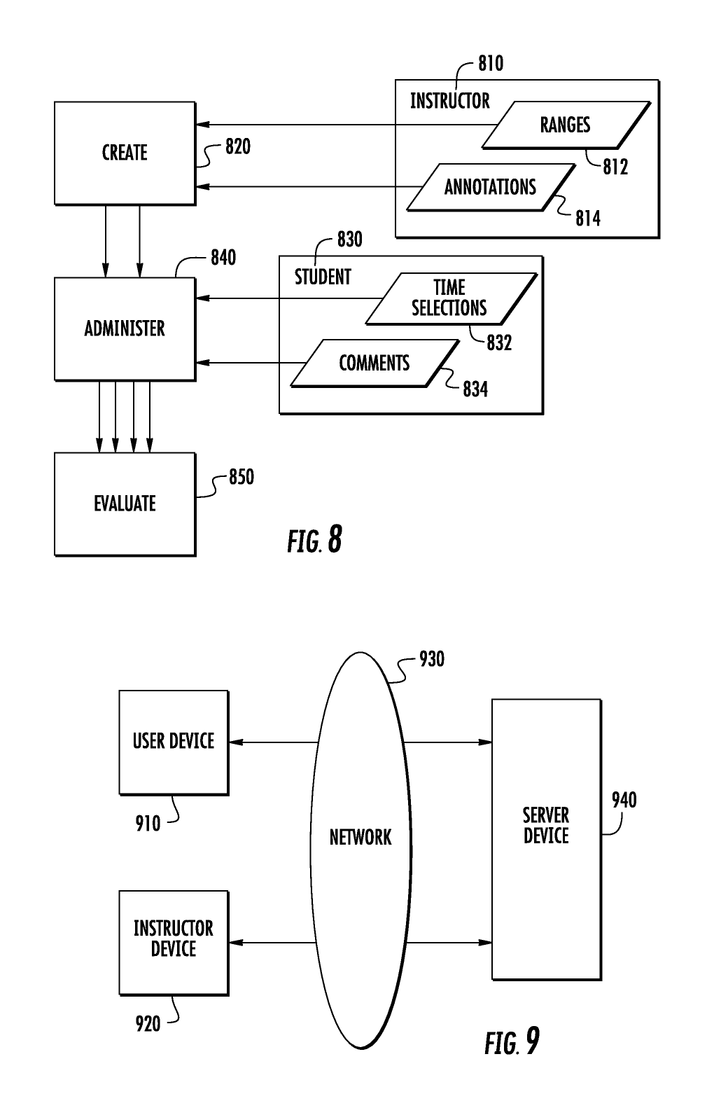

FIG. 7 shows an evaluation data table 700 that results from a method of FIG. 1, which results from the evaluation shown in FIG. 6. The table has scoring 710 and annotation 720 records.

After the selections are evaluated, the student may be presented with feedback on their performance. The student may be shown the time ranges associated with each annotation, and the time ranges may be juxtaposed with the student's own selection times so that they may be visually compared. The student may also be graded by assigning a numeric or qualitative score based upon the evaluation results, for example. The form or forms of feedback presented to the user may depend upon whether the video assignment's purpose is for instructional or grading purposes. The results of the evaluation may also be used to identify learning style, or personality traits about the student.

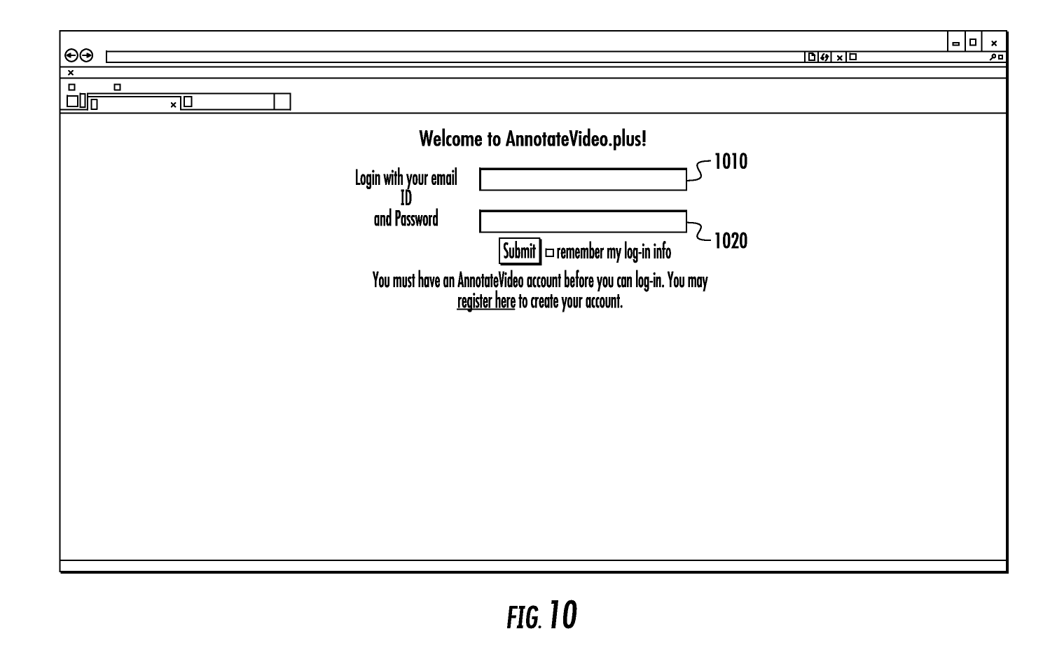

FIG. 8 shows an example of data flow during creation of an annotated video, administration of an assignment based on the annotated video, and evaluation of the results of the assignment as described with respect to FIGS. 1-7. In the data flow, an instructor 810 inputs ranges 812 and annotations 814 during a creation phase 820. During an administration phase 840, a student 830 provides time election input 832 and/or comments 834. Finally, during an evaluation phase 850, the system compares the instructor annotations to the student time selections.

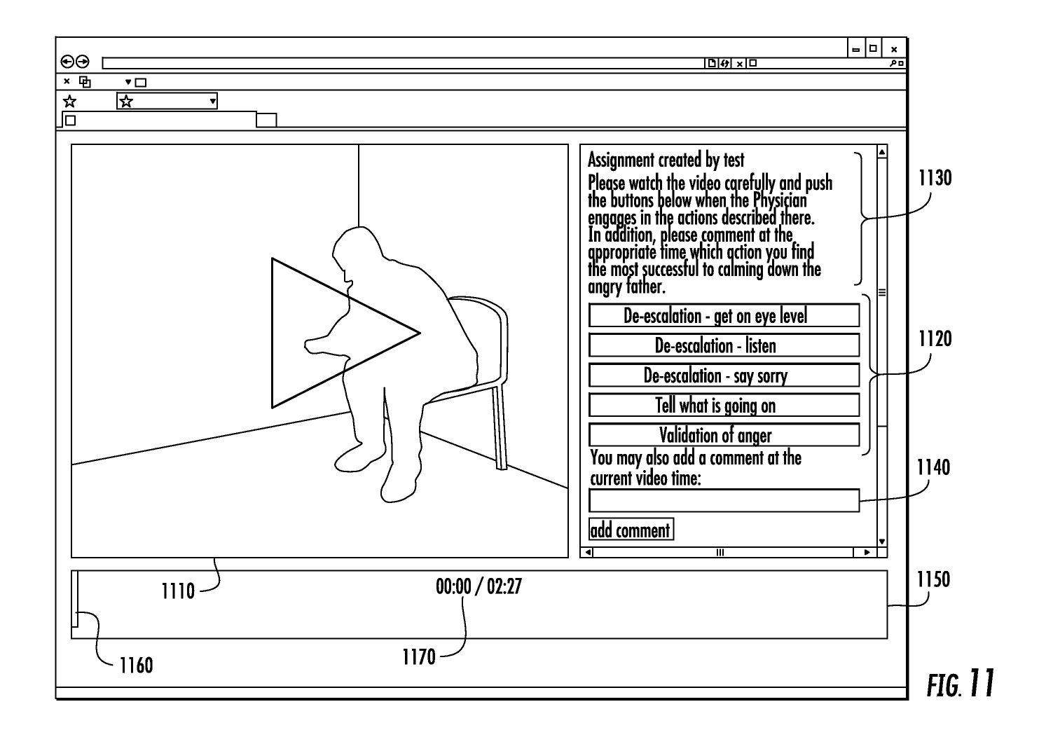

FIG. 9 shows an example implementation of a system for implementing the methods described with respect to FIGS. 1-8 with user devices 910 and instructor devices 920 interacting with a server device 940 via a network 930. The user device 910 and instructor device 920 may each include a personal computer or other computing device capable of accessing the server device over the network.

The server device 940 may be a web server or other suitable computing device.

The network 930 may be the Internet, a subset of the internet, a Local Area Network, or any other suitable computer communications network.

In this example topology, the creation, administration, and evaluation steps described with respect to FIG. 1 and otherwise herein may be each performed using software executing on the server device, as directed from the user and instructor devices.

Those having skill in the art will appreciate however that the instructor device and student device may, in some implementations, be the same device used at different times (not shown), and that in some implementations, the creation, administration, and evaluation functions may all take place on one machine without the need for a server device or computer communications network (not shown).

FIGS. 10-24 are example graphical user interface screens illustrating aspects of video learning devices and methods described herein.

FIG. 10 shows a login window where a user (teacher or student) may enter their login 1010 and password 1020.

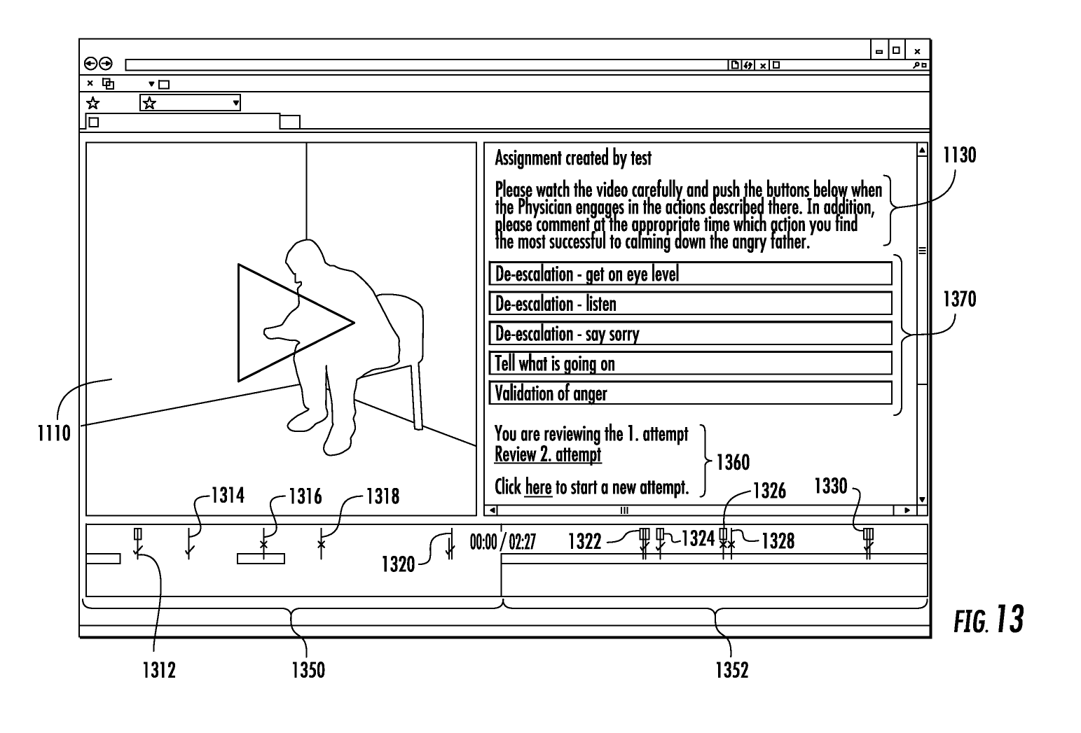

FIG. 11 shows a graphical user interface usable for administering an assignment as described above.

The graphical user interface includes a video display window 1110 and a selection palette of annotations 1120 previously associated with certain time ranges within the video. There may also be an instruction area 1130 to help guide a user.

In this example, the video presents a scenario where a doctor interacts with an angry relative of a patient, and the annotations relate to different techniques that the doctor may use to calm the relative. It will be understood that this particular learning scenario is only exemplary, and that many other types of video situations and annotations are possible.

A free-form text box 1140 allows for the student to enter their own annotation at a particular time within the video.

A time bar 1150 located below the video and annotations includes a time slider cursor 1160 that indicates the current video time shown. The screen also shows elapsed time and total time 1170.

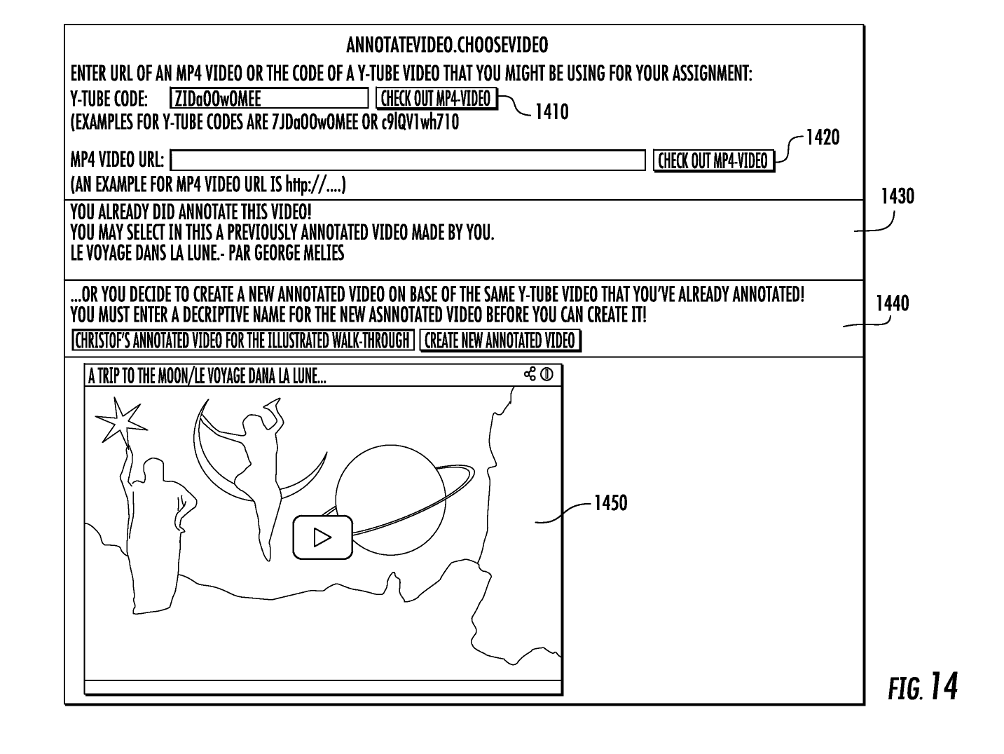

FIG. 12 shows the graphical user interface of FIG. 11 during the presentation of the video within the display window 1110. Several selections 1210 from the list of annotations are shown associated with particular times during the video. In this example, each selection corresponds to a marker 1212, 1214, 1216, 1218, 1220, 1222 placed along the video timeline 1150. Although not apparent in the black-and-white figure, the markers may be color coded to correspond to the particular annotation they represent, although in some implementations the correspondence may be shown in another way, such as by using a number or letter, or this correspondence may be omitted.

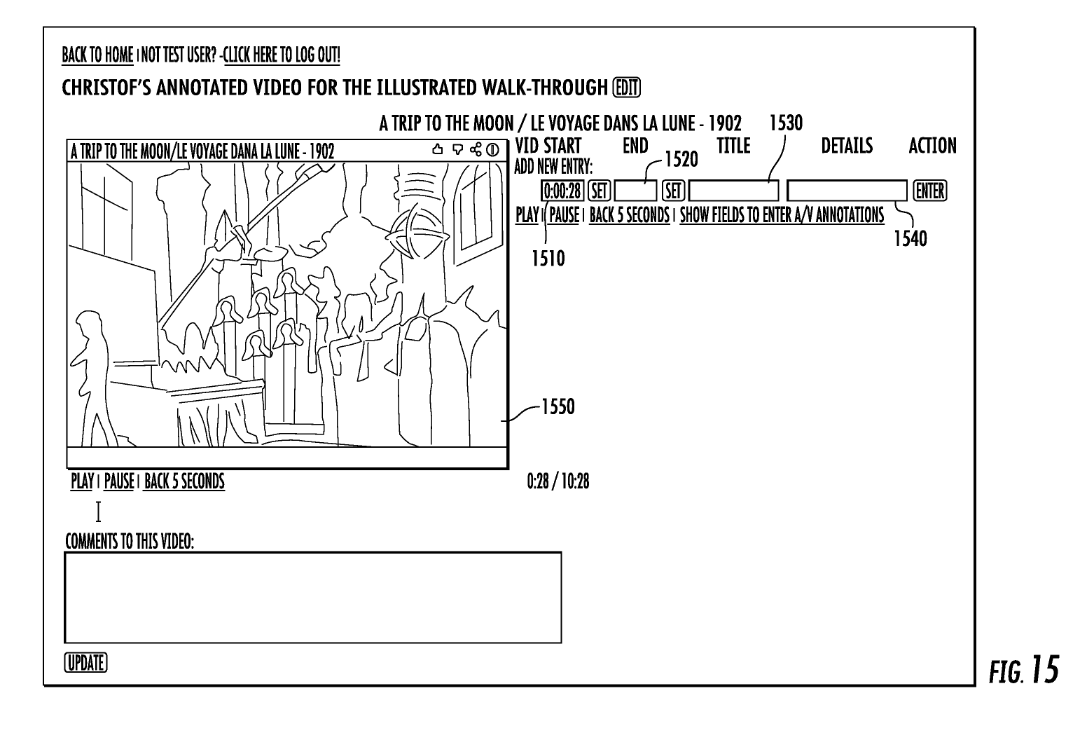

FIG. 13 shows the graphical user interface of FIGS. 11 and 12 after evaluation of the student's selections during presentation of the video. The markers 1312, 1314, 1316, 1318, and 1320 placed along the timeline 1350 that correspond to the student's annotation selections while watching the video are marked with a check or cross corresponding to correct or incorrect depending upon whether or not the selection fell within a time range that the teacher configured to correspond to that annotation.

A parallel timeline 1352 shows the ranges 1322, 1324, 1326, 1328, and 1330 associated with each annotation. The different ranges may be differentiated using color coding, hash marks, shading, or other suitable markings which may also correspond to the associated annotation and selection markers on the timeline. A review of the answers may also be seen in an answer status window 1370, and an attempt status window 1360 shows the attempts undertaken by a student.

FIG. 14, described also above, shows an example interface for video input in preparation for annotating the video. As shown, a video may be chosen for annotation by entering location information for a video which is accessible to the user in an input box 1410. For example, the user may enter a YouTube code or an identifier for another online video hosting service to select a video for annotation. The user may also enter a uniform resource locator (URL) or other network path information identifying a video stored on a server accessible over the internet or another network in another box 1420. A previously annotated video may also be selected in order to create a new annotated video in another box 1440. Any other suitable means for identifying a video resource for annotation may also be used. For example, a video located on an attached flash drive or other medium may also be selected.

FIG. 15, also discussed above, shows an example interface for selecting and annotating time ranges of a video. The user may set start and end times for each annotation either by watching or navigating the video and selecting the displayed point, or by manually or otherwise entering the start and end times 1510, 1520. Each annotation may be given a title 1530, details 1540, and/or comments, such as editorial content, secondary information, or other information.

In this example, a “TITLE” and “DETAILS” field are provided, although other fields may also be provided. Here, information entered in the “TITLE” field will be displayed to viewers of the annotation in bold, and information entered in the “DETAILS” filed will be displayed to viewers of the annotation in regular type. It will be understood that these fields may also be used in other ways. A hyperlink, button, or other selection mechanism may be provided (in this example, a hyperlink: “show fields for entering A/V annotations”) to allow the user to enter further annotation information as shown in FIG. 16.

FIG. 16, described above, shows further features of the annotation interface of FIG. 15 including an annotation that includes a hyperlink 1610. An annotation for a portion of a video may have a start time (Ts) of 0:04:42 1510 and an end time (Te) of 0:04:44 1520. The annotation includes information fields for a title, details, type, location, and link.

Annotation information may be entered using the fields “TYPE”, “LOC,” and “LINK,” although other fields are possible. The “Type” may be as a hyperlink, although other types are possible, including video, text, or other suitable annotation types (not shown). “LOC” refers to a location for displaying video annotations. Video annotations may be presented in windows overlaying the main video. Such video annotations may be used for example to reveal what is going on in the minds of a physician (explanation of decision-making) or a patient (explanation what they perceive is going on). By displaying the overlaying video annotation on the right, on the center, or on the left of the screen, the video annotation can be shown over the protagonist who is “generating” the comment: the patient reflecting on what is going on is shown on top of the patient for example “LINK” may be used when the “TYPE” is “URL” and contains path information to the content of the annotation. Because the annotation type in this example is a hyperlink, the “LINK” field is shown populated with a URL for the desired content of the annotation. As shown in FIG. 16, the annotation is a web page that a user opens in a separate window 1650 from the annotated video 1550.

FIG. 17 shows the interface for selecting and annotating time ranges with further features including an annotation that includes a video 1750. In this example, annotation fields “VID,” “START,” “END,” “TITLE,” “DETAILS,” “TYPE,” “LOC,” and “LINK” are shown, although others are possible.

An annotation may be for a portion of a video defined by a start time (Ts) of 0:05:17 1760 and an end time (Te) of 0:05:34 1770. Accordingly, the “START” and “END” fields reflect these values. A title and details are likewise provided in the appropriate fields.

The “TYPE” field 1780 may indicate the annotation type as a mp4url, indicating that the annotation includes a video in mp4 format which is accessible over the Internet at a particular URL. An icon populated in the “VID” field visually indicates that this annotation is a video annotation. The “LINK” field populated with a URL indicates where the annotation video is located, and the “LOC” field 1790 specifies that the annotation video may be displayed toward the left side of the video as shown in FIG. 17.

With an annotation that includes a video, the main video may be moved to the time mark corresponding to the start of the annotation (i.e. Ts), stopped, and the annotation video may be played for the viewer. Thereafter, the annotation video may close and the main video may resume playing.

Two other example annotations are in FIG. 17 having start times of 2:58 and 4:42 respectively. The annotation at 4:42 is a hyperlink annotation as described with respect to FIG. 16. The VID field for this annotation shows an icon indicating that the annotation is a hyperlink. The annotation at 2:58 is a text annotation having only a title. Accordingly, the VID, TYPE, and LINK fields for this annotation are empty as shown.

The timeline may be shown along the bottom of the video showing the current transport position of the video as well as graphically illustrating the ranges for each of the three annotations. Although this timeline is separate from the transport controls timeline slider of the video as shown, in some implementations these features may be integrated.

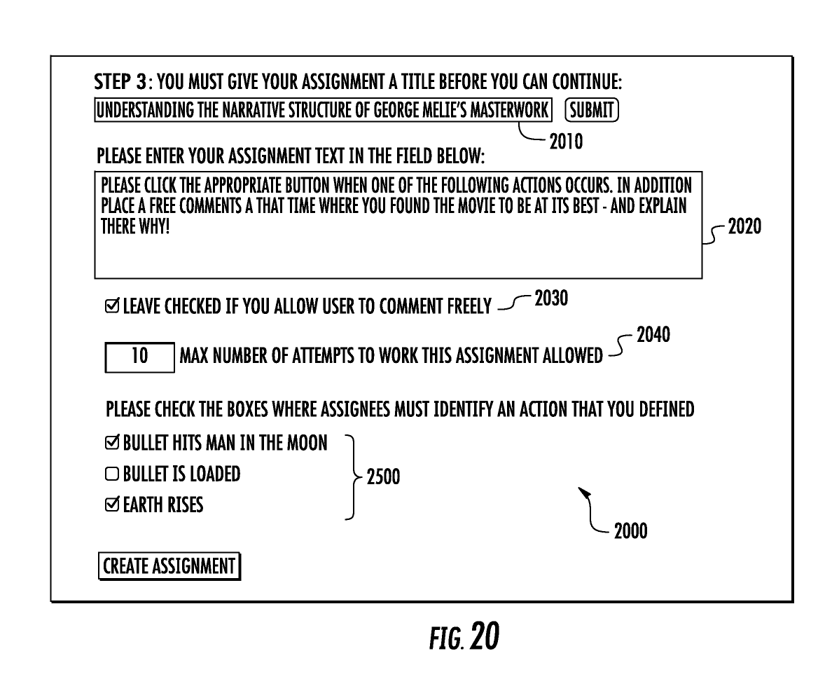

FIG. 18 shows an annotated video 1820 during playback. Here, a user selected the second annotation 1820 and the system advanced the main video 1830 to the corresponding range for this annotation, as shown in the timeline 1810. The hyperlink for this annotation may open a separate window to display the content at the corresponding URL (as shown with respect to FIG. 16).

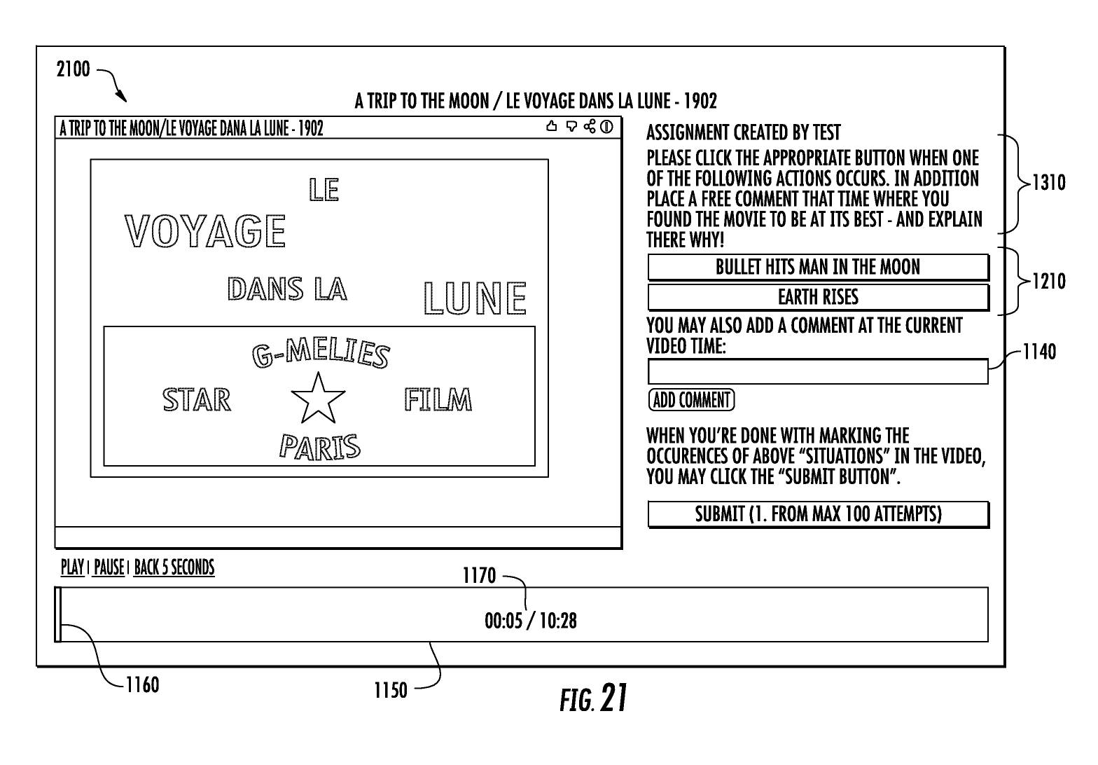

FIG. 19 shows an editing interface for the start time, end time, and title of an annotation. Here, the start and end times 1920, 1930 may be typed into fields, or the start and end points for the annotation shown on the annotation timeline shown toward the bottom of FIG. 19 may be “dragged” to move them along the timeline 1910. In some implementations, these or other fields may be selected for editing by selecting the field, whereupon an editable text field, slider, selection box, or other appropriate editing interface will appear.

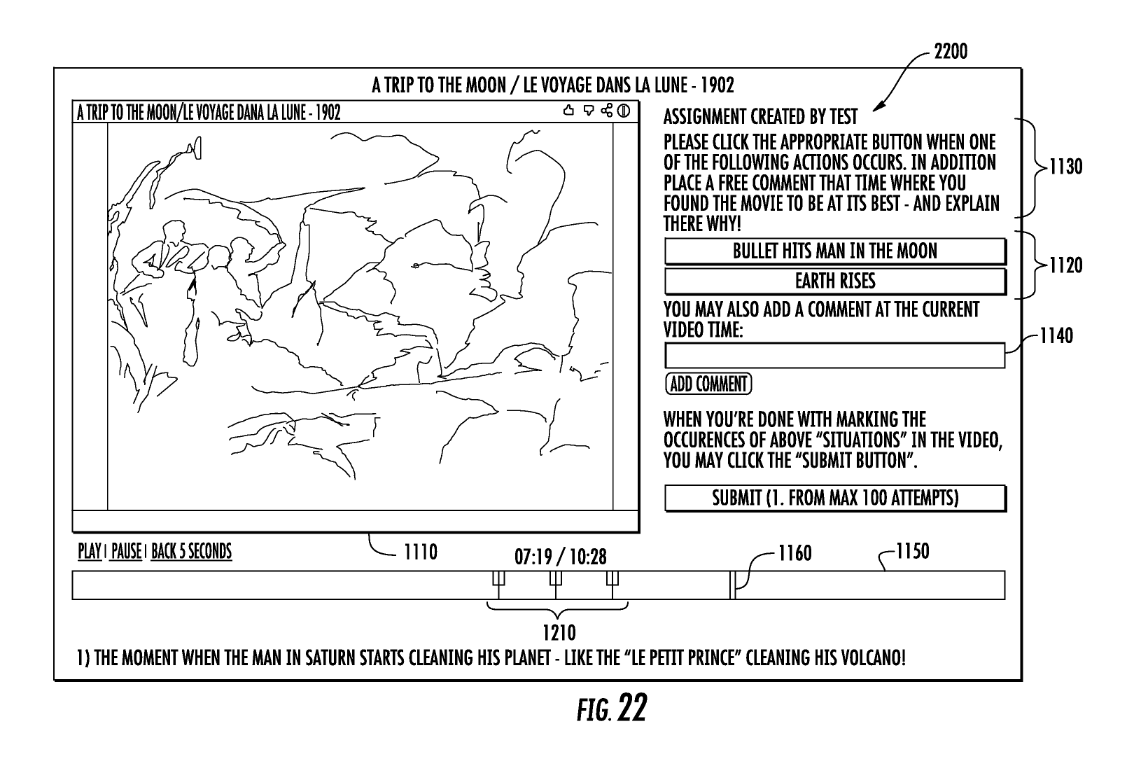

FIG. 20 shows a graphical interface 2000 usable for creating an assignment based upon an annotated video. It allows for input of a title 2010, text related to an assignment 2020, a box to allow for a user to comment freely 2030, a maximum number of attempts that a user may work on the assignment 2040, and a video selection area 2050.

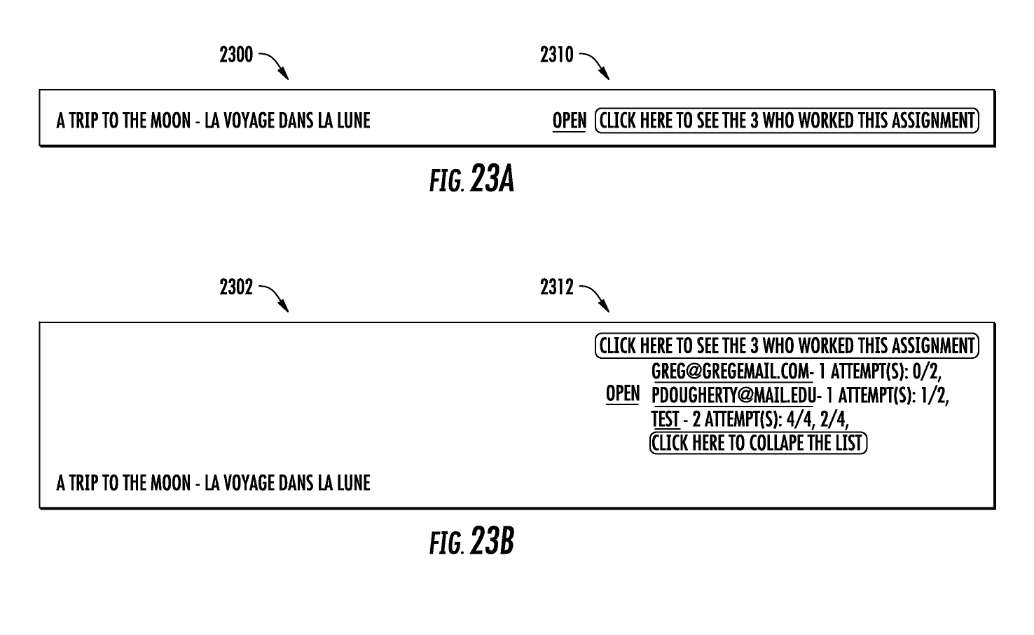

FIG. 21 shows an example interface 2100 for a user to whom an assignment based upon the annotated video. This interface may be similar to the interface described above with respect to FIG. 11.

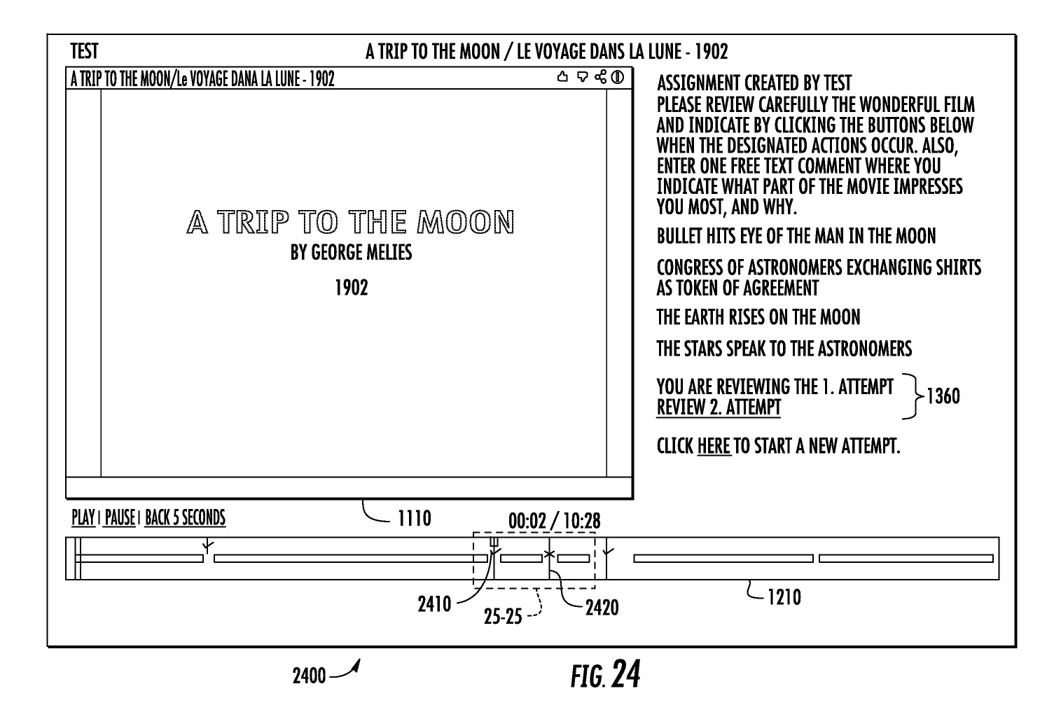

FIG. 22 shows the interface 2200 of FIG. 21 after the user has made several selections, similar to FIG. 12 described above.

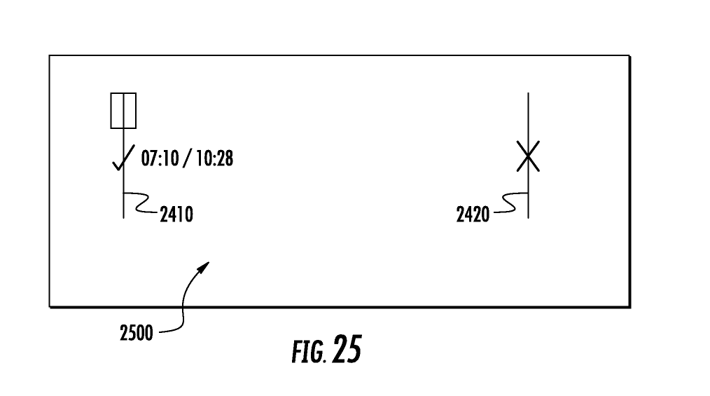

FIGS. 23A and 23B shows an example interfaces 2300 and 2302 for an administrator of an assignment based upon an annotated video, whereby scoring information for various users to whom the assignment was administered may be displayed 2310 and 2312. By selecting button 2310, a user can see the information 2312.

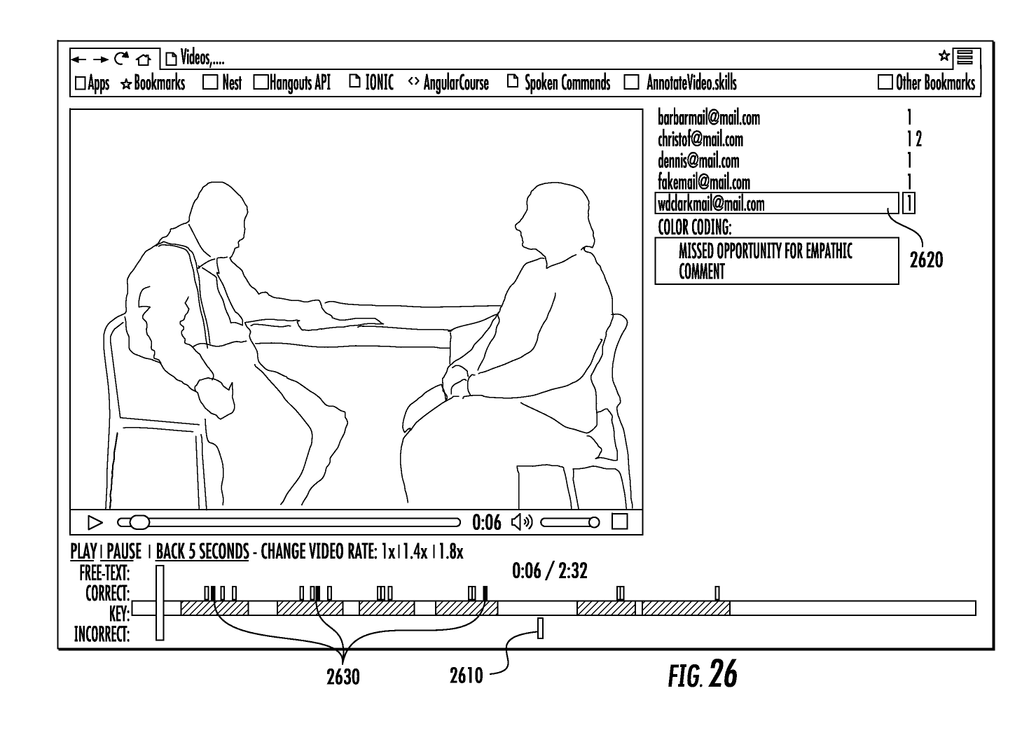

FIG. 24 shows an example interface 2400 whereby correct and incorrect selections made by a user to whom an assignment based upon the annotated video was administered may be displayed. In this example, correct and incorrect selections are displayed with a “check” and “x” mark on a given selection point on the timeline respectively for a correct and incorrect selection, similar to FIG. 13 described above.

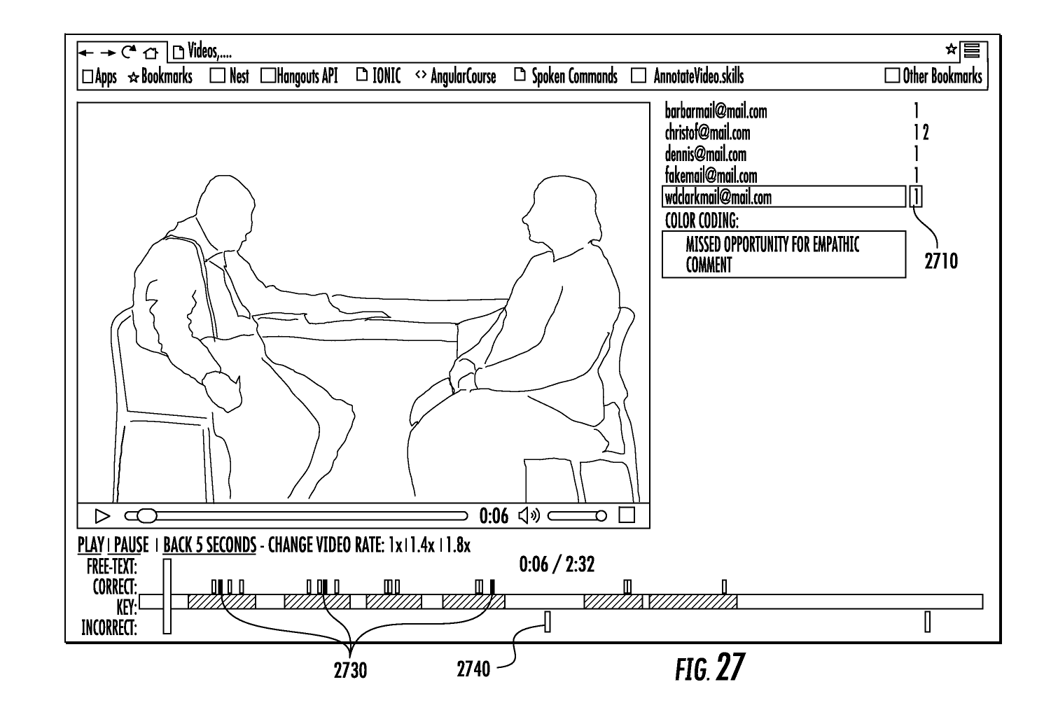

FIG. 25 is an enlarged view of a portion 2500 of the interface shown in FIG. 24.

As used herein, the term “video” may refer to a motion picture and does not exclude any particular storage or presentation format. As used herein, the term “computing device” refers to any computing device having a processor, such as a personal computer, server computer, smart phone, personal digital assistant (PDA), laptop computer, tablet computer, or the like, and is capable of executing software stored on a non-transitory computer-readable medium.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

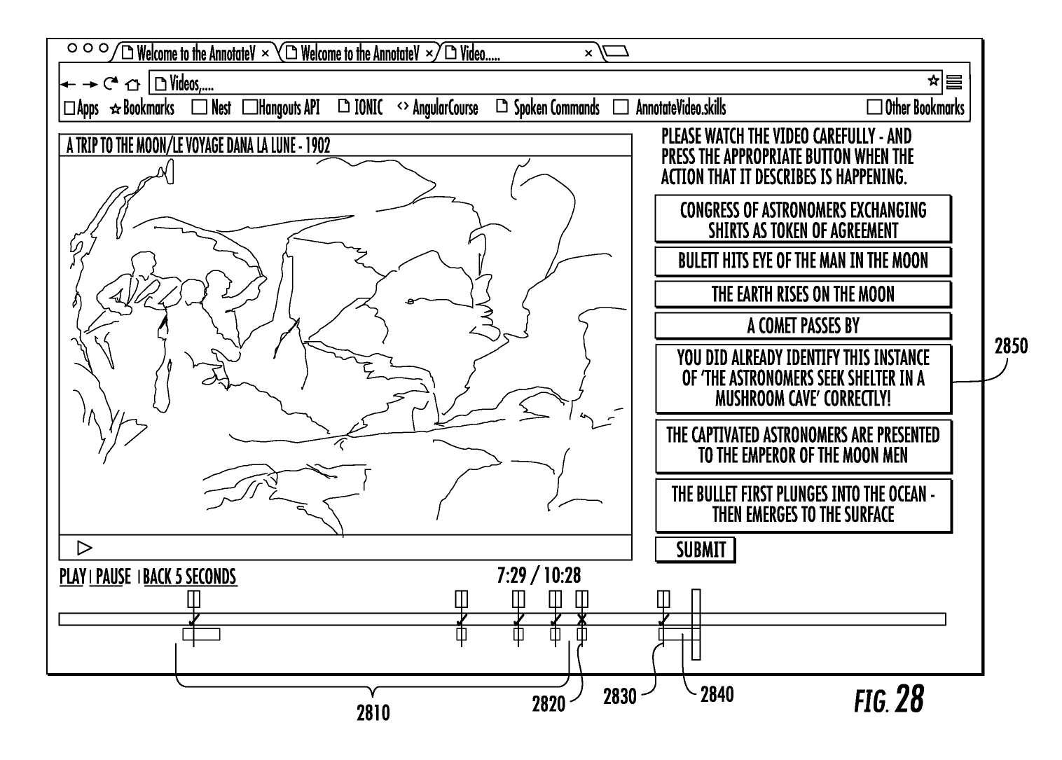

FIG. 26 shows the application in use and in particular how hovering the cursor over an outliner 2610 (perhaps in a red color) in the “incorrect” section highlights the corresponding user (wdclark@gwi.net) 2620 and user-attempt (1) when this outliner was placed, and it highlights the correct markers 2630 that were set by the user during the same attempt in another color like green (during other attempts by the same user they may be marked in a third color like orange).

FIG. 27 shows how hovering over a user's attempt (wdclark@gwi.net, 1st attempt 2710) the users markers are highlighted: correctly set markers show in on color such as green 2730, incorrect in another color such as red 2740.

FIG. 28 shows how a user selected the first 4 markers 2810 correctly, then got an incorrect attempt 2820, and got the 5th marker 2830 correct again. FIG. 28 also shows how the user can't set more than 1 correct marker per task: when a marker was set correctly, the underlying timeframe for that marker is made visible through a colored-bar 2840. Any further attempt to score again for the same task is then denied, and the button text 2850 is changed for 3 seconds alerting the user of this fact (“You did already identify this instance of ‘The Astronomers seek shelter in a mushroom cave’ correctly!).

This feature answers the task “how to compute a single numeric score that correlates with how well a user understands what is going on in a video” in a this way:

When a user sets a correct marker, the system shows the timeframe for which the marker is valid, and scores+2 to the final result (the system could also be set up to allow to weight the score changes depending on the importance for the assignment). The system denies the user to score again during the revealed time frame.

When a user sets an incorrect marker, it scores −1 to the final result.

When a user misses to identify a task at time of submission, it scores −2 to the final result (the system may also weight the score changes depending on the importance for the assignment).

When applying this algorithm to the situation in above illustration, the system computes a score of 5 as follows:

+2 for identifying correctly “Congress of Astronomers . . . ”

+2 for identifying correctly “Bullet hits eye of the Man in the Moon . . . ”

+2 for identifying correctly “The Earth rises on the Moon”

+2 for identifying correctly “A comet passes by”

−1 for identifying incorrectly “A comet passes by”

+2 for identifying correctly “The Astronomers seek shelter . . . ” (the second attempt to place a marker here has no effect)

−2 for missing to identify “The captivated Astronomers are presented . . . ”

−2 for missing to identify “The bullet first plunges into the Ocean . . . ”

Although the embodiments have been described with reference to a particular arrangement of parts, features and the like, these are not intended to exhaust all possible arrangements or features, and many modifications and variations will be ascertainable to those of skill in the art. Each feature or element can be used alone or in any combination with or without the other features and elements. For example, each feature or element as described herein may be used alone without the other features and elements or in various combinations with or without other features and elements. Sub-elements of the methods and features described herein may be performed in any arbitrary order (including concurrently), in any combination or sub-combination.

1. A video learning device for administering a comparison test comprising:
identifying an annotation;
associating the annotation with a time range within a video;
presenting the video and the annotation to a user;
receiving a selection of a time point within the video from the user; and
evaluating if the time point corresponds to the time range.

2. The device of claim 1, wherein the time range is withheld from the user while the video is being presented.

3. The device of claim 1, further configured to receive a comment from the user and a comment time point within the video associated with the comment.

4. The device of claim 1, wherein the annotation comprises text.

5. The device of claim 1, wherein the annotation comprises a video.

6. The device of claim 1, wherein the annotation comprises a URL.

7. The device of claim 1, further comprising presenting a visual comparison of the evaluation step.

8. The device of claim 7, wherein the visual comparison comprises a timeline corresponding to the length of the video.

9. The device of claim 8, wherein the timeline comprises annotation markers that correspond to associated annotations.

10. The device of claim 9, wherein the markers are marked with an indication of a correct or incorrect selection.

11. A method for video learning comprising:
identifying an annotation;
associating the annotation with a time range within a video;
presenting the video and the annotation to a user;
receiving a selection of a time point within the video from the user; and
evaluating if the time point corresponds to the time range.

12. The device of claim 11, wherein the time range is withheld from the user while the video is being presented.

13. The device of claim 11, further configured to receive a comment from the user and a comment time point within the video associated with the comment.

14. The device of claim 11, wherein the annotation comprises text.

15. The device of claim 11, wherein the annotation comprises a video.

16. The device of claim 11, wherein the annotation comprises a URL.

17. The device of claim 11, further comprising presenting a visual comparison of the evaluation step.

18. The device of claim 17, wherein the visual comparison comprises a timeline corresponding to the length of the video.

19. The device of claim 18, wherein the timeline comprises annotation markers that correspond to associated annotations.

20. A video learning system comprising:
a recording subsystem configured to record an annotation and a time range within a video associated with the annotation;
a receiving subsystem configured to receive a selection of a time point within the video; and
a determining subsystem configured to determine whether the time point falls within the time range.
